(19) United States
(12) Patent Application Publication
(10) Pub. No.: US 2013/0187888 A1
(43) Pub. Date: Jul. 25, 2013

(54) DISPLAY DEVICE

(71) Applicants: Satoru TOMITA, Kawagoe-shi (JP); Masahiro Tada, Tokyo (JP); Takashi Okada, Kumagaya-shi (JP); Hideyuki Takahashi, Konosu-shi (JP); Miyuki Ishikawa, Kumagaya-shi (JP); Takashi Nakamura, Saitama-shi (JP)

(72) Inventors: Satoru TOMITA, Kawagoe-shi (JP); Masahiro Tada, Tokyo (JP); Takashi Okada, Kumagaya-shi (JP); Hideyuki Takahashi, Konosu-shi (JP); Miyuki Ishikawa, Kumagaya-shi (JP); Takashi Nakamura, Saitama-shi (JP)

(21) Appl. No.: 13/724,899

(22) Filed: Dec. 21, 2012

(30) Foreign Application Priority Data
Jan. 23, 2012 (JP) 2012-011402

(51) Int. Cl. G06F 3/044

(52) U.S. Cl. CPC G06F 3/044
USPC 345/174

(57) ABSTRACT

According to one embodiment, a display device includes, a module which divides a display surface of the display device into a plurality of regions composed of a plurality of display pixels and a plurality of sensor circuits and which causes a part of the sensors in each of the regions to perform a normal operation of reading the magnitude of capacitive coupling, a module which causes the other sensor circuits in the same region to perform a correction operation of not reading the magnitude of capacitive coupling, and a module which determines the magnitude of capacitive coupling using the difference between output signals from the sensor circuits that perform the normal operation in the corresponding regions and output signals from the sensor circuits that perform the correction operation.

### CROSS-REFERENCE TO RELATED APPLICATIONS

This application is based upon and claims the benefit of priority from Japanese Patent Application No. 2012-011402, filed Jan. 23, 2012, the entire contents of which are incorporated herein by reference.

### FIELD

Embodiments described herein relate generally to a display device.

### BACKGROUND

An electronic device provided with a display device that has a touch panel function as a user interface, such as a mobile phone, a personal digital assistant, or a personal computer, has been developed. As for such an electronic device with a touch panel function, the idea of laminating a separate touch panel substrate to a display device, such as a liquid-crystal display device or an organic EL display device, to add a touch panel function is under consideration.

In recent years, efforts have been directed toward researching the technique for manufacturing an image reading device by forming a thin film on a transparent insulating substrate, such as a glass substrate, by chemical vapor deposition (CVD) techniques or the like using various materials and repeating cutting and grinding operations and the like to form display elements composed of scanning lines and signal lines, optical sensor elements, and the like.

In addition, as for a reading method for the image reading device, studies have been conducted on the technique for detecting a contact position by a so-called capacitance method by arranging a conductive electrode in place of an optical sensor element or the like and detecting information on a finger or the like on the panel surface according to a variation in the capacitance between the electrode and a finger or the like.

In the field of display devices using the capacitance method, the technique for incorporating a sensor function into a display panel, such as a liquid-crystal panel, what is called in-cell technology, is being developed actively. In the in-cell technology, there is no need to laminate a separately produced touch panel to a liquid-crystal panel or the like and therefore an increase in the thickness or weight of the entire electronic device can be avoided. In addition, since there is no interface between the liquid-crystal panel or the like and the touch panel, the reflection of light liable to take place at the interface does not occur, making the display device excellent in display quality.

Generally, the capacitance of a finger is very low and therefore it is not easy for a sensor circuit to read accurately the presence or absence of contact with a finger in the form of the magnitude of capacitive coupling. In addition, variations in the characteristic of TFTs used in a sensor circuit, environmental variations or the like, including temperatures, contribute to noise, which makes it difficult to read the magnitude accurately. In the in-cell technology, signals from display pixels around the sensor circuit act as additional noise, making it more difficult to read the magnitude accurately.

### BRIEF DESCRIPTION OF THE DRAWINGS

FIG. 1 is a schematic exemplary plan view showing the configuration of a display device according to an embodiment;

FIG. 2 is an exemplary sectional view of the display device according to the embodiment;

FIG. 3 is an exemplary diagram showing an equivalent circuit of a sensor circuit according to the embodiment;

FIG. 4 shows an exemplary timing chart to explain a method of driving the display device according to the embodiment;

FIG. 5 is an exemplary diagram schematically showing the arrangement of sensors in the display device according to the embodiment; and

FIG. 6 is an exemplary timing chart to explain the operation of sensors in the display device according to the embodiment.

### DETAILED DESCRIPTION

Various embodiments will be described hereinafter with reference to the accompanying drawings.

In general, according to one embodiment, a display device comprising: a plurality of display pixels which are arranged in a matrix; a plurality of sensor circuits which read the magnitude of capacitive coupling; a module which divides a display surface of the display device into a plurality of regions composed of a plurality of display pixels and a plurality of sensor circuits and which causes a part of the sensors in each of the regions to perform a normal operation of reading the magnitude of capacitive coupling; a module which causes the other sensor circuits in the same region to perform a correction operation of not reading the magnitude of capacitive coupling; and a module which determines the magnitude of capacitive coupling using the difference between output signals from the sensor circuits that perform the normal operation in the corresponding regions and output signals from the sensor circuits that perform the correction operation.

Hereinafter, a display device according to an embodiment and a method of driving the display device will be explained with reference to the accompanying drawings.

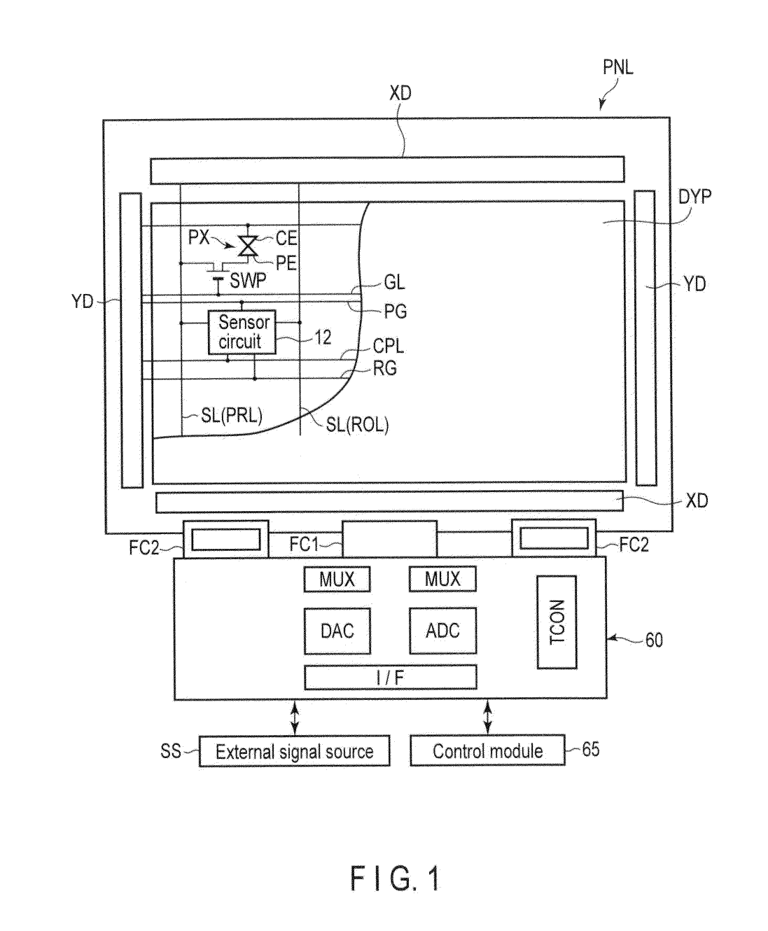

FIG. 1 is a schematic exemplary plan view showing the configuration of the display device according to the embodiment.

The display device 1 of the embodiment comprises a liquid-crystal display panel PNL and a circuit board 60. To one end of the liquid-crystal display panel PNL, one end of a flexible substrate FC1 and that of each flexible substrate FC2 are electrically connected. To the other ends of the flexible substrates FC1, FC2, the circuit board 60 is electrically connected.

The liquid-crystal display panel PNL comprises a display module DYP composed of a plurality of pixels arranged in a matrix, scanning line driving circuits YDs, and signal line driving circuits XDs, the scanning line and signal line driving circuits being arranged around the display module DYP. The circuit board 60 controls not only a display operation of the display device but also sensor circuits (described later) provided at the liquid-crystal display panel PNL. Specifically, the circuit board 60 outputs a video signal obtained from an external signal source SS to the liquid-crystal display panel PNL. In addition, the circuit board 60 not only supplies a signal for operating the sensor circuits but also outputs output signals obtained from the sensor circuits to a control module 65.

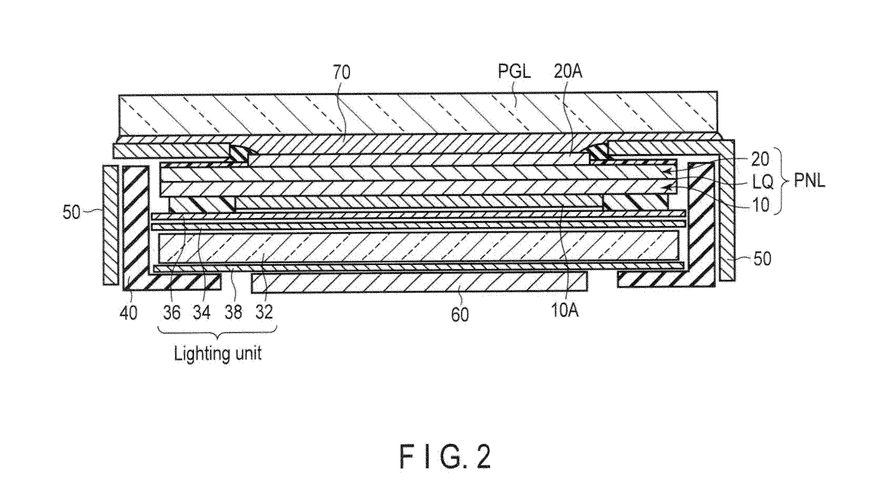

FIG. 2 is an exemplary sectional view of the display device according to the embodiment.

The display device 1 of the embodiment comprises a liquid-crystal display panel PNL, a lighting unit, a frame 40, a bezel cover 50, a circuit board 60, and a protective glass PGL.

The lighting unit is arranged on the back face side of the liquid-crystal display panel PNL. The frame 40 supports the liquid-crystal display panel PNL and the lighting unit. The bezel cover 50 is provided on the frame 40 to expose the display module DYP of the liquid-crystal display panel PNL. The circuit board 60 is arranged on the back face side of the frame 40. The protective glass PGL is fixed on the bezel cover 50 with an adhesive 70.

The liquid-crystal display panel PNL comprises an array substrate 10, an opposite substrate 20 arranged to face the array substrate 10, and a liquid-crystal layer LQ sandwiched between the array substrate 10 and the opposite substrate 20. The array substrate 10 includes a polarizing plate 10A provided on a principal surface opposite the liquid-crystal layer LQ. The opposite substrate 20 includes a polarizing plate 20A mounted on a principal surface opposite the liquid-crystal layer LQ.

The lighting unit includes a light source (not shown), a light guiding unit 32, a prism sheet 34, a diffusion sheet 36, and a reflective sheet 38.

The light guiding unit 32 emits light input from the light source toward the liquid-crystal display panel PNL. The prism sheet 34 and diffusion sheet 36 are optical sheets arranged between the liquid-crystal display panel PNL and the light guiding unit 32. The reflective sheet 38 is arranged to face the principal surface of the light guiding unit 32 opposite the liquid-crystal display panel PNL. The prism sheet 34 and diffusion sheet 36 gather and diffuse rays of light emitted from the light guiding unit 32.

The protective glass PGL protects the display module DYP of the liquid-crystal display panel PNL from an external shock. The protective glass PGL may be omitted.

Next, the display device of FIG. 1 will be explained in detail.

The liquid-crystal display panel PNL is configured to sandwich a liquid-crystal layer LQ between the array substrate 10 and an opposite substrate 20, which form a pair of electrode substrates. The transmissivity of the liquid-crystal display panel PNL is controlled by a liquid-crystal driving voltage applied to the liquid-crystal layer LQ from a pixel electrode PE provided on the array substrate 10 and a common electrode CE provided on the opposite substrate 20.

In the array substrate 10, a plurality of pixel electrodes PE are arranged almost in a matrix on a transparent insulating substrate (not shown). A plurality of gate lines GLs are arranged along a plurality of rows of pixel electrodes PEs and a plurality of signal lines SLs are arranged along a plurality of columns of pixel electrodes PEs.

Each pixel electrode PE and the common electrode CE are made of transparent electrode material, such as indium tin oxide (ITO), and each are covered with an alignment film AL. The pixel electrode PE and common electrode CE, together with a pixel block, a part of the liquid-crystal layer LQ, constitute a liquid-crystal pixel PX.

Near a position where a gate line GL and a signal line cross, a plurality of pixel switches SWPs are arranged. Each pixel switch SWP is, for example, a thin-film transistor (TFT). In the pixel switch, the gate is connected to a gate line GL and the source-drain path is connected between a signal line SL and a pixel electrode PE. When the pixel switch has been driven via the corresponding gate line GL, the path conducts between the corresponding signal line SL and the corresponding pixel electrode PE.

In addition, the array substrate 10 is provided with a sensor circuit 12. A coupling pulse line CPL, a precharge gate line PG, and a read gate line RG are arranged along rows of pixel electrodes PEs.

In the embodiment, the signal line SL is also used as a precharge line PRL for supplying a signal for driving the sensor circuit 12 and a read line ROL. A detailed operation of this will be described later.

The scanning line driving circuit YD applies gate voltages for turning on pixel switches SWP (to cause the source-drain path to conduct) to the gate lines GLs, thereby driving the gate lines GLs sequentially. In addition, the scanning line driving circuit YD drives a plurality of coupling pulse line CPLs, a plurality of precharge gate lines PGs, and a plurality of read gate lines RGs with specific timing, thereby driving the sensor circuit 12.

The signal line driving circuit XD supplies a video signal from a signal line SL to a pixel electrode PE via a pixel switch SWP whose source-drain path has conducted.

The circuit board 60 includes a multiplexer MUX, a digital-to-analog conversion module DAC, an analog-to-digital conversion module ADC, an interface module I/F, and a timing controller TCON.

The timing controller CONT controls the operations of various modules mounted on the circuit board 60 and the operations of the scanning line driving circuit YD, signal line driving circuit XD, common electrode driving circuit, and sensor circuit 12.

A digital video signal taken in from an external signal source SS via an interface module I/F is converted into an analog signal by the digital-to-analog conversion module DAC and output to a signal line SL with specific timing by the multiplexer MUX.

The output signal from the sensor circuit 12 is supplied with specific timing from the multiplexer MUX to the analog-to-digital conversion module ADC, converted into a digital signal, and then supplied to the interface module I/F. The interface module I/F outputs the received digital signal to the control module 65. The control module 65 detects from the received digital signal whether contact has been made and calculates coordinates, thereby detecting a coordinate position where a fingertip, a stylus tip, or the like has touched.

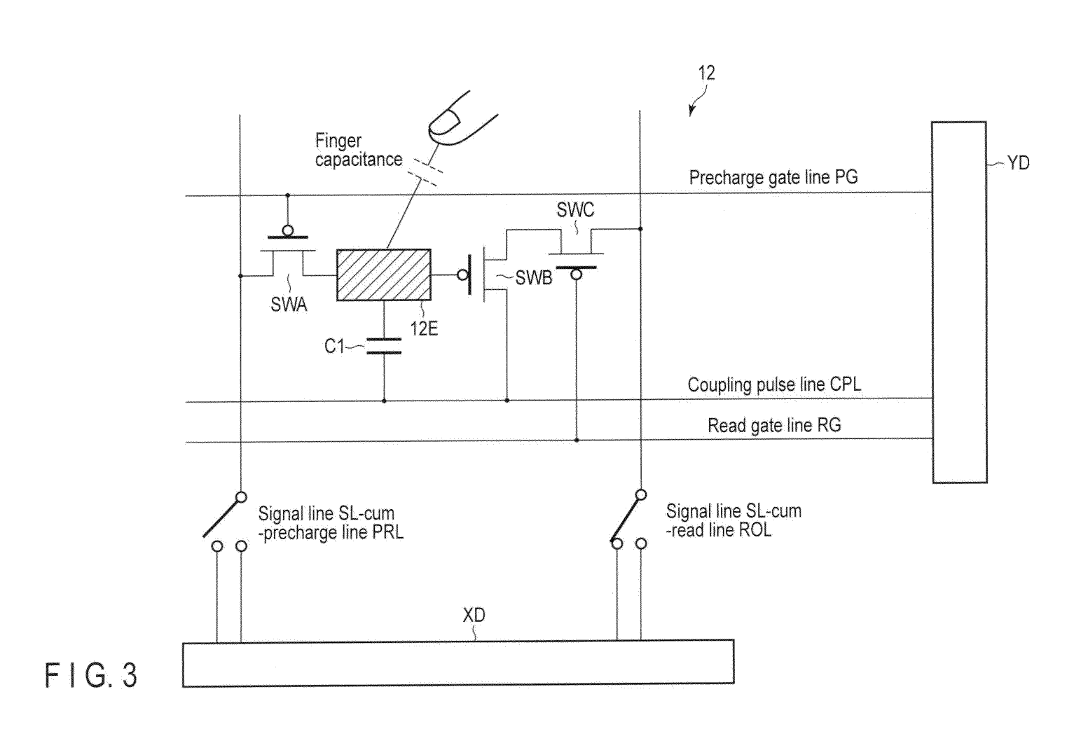

FIG. 3 is an exemplary diagram showing an equivalent circuit of the sensor circuit 12 according to the embodiment.

The sensor circuit 12 includes a detection electrode 12E, a precharge line PRL, a read line ROL, a precharge gate line PG, a coupling pulse line CPL, a read gate line RG, a precharge switch SWA, a coupling capacitance C1, an amplification switch SWB, and a read switch SWC.

The detection electrode 12E detects a variation in the detected capacitance caused by the presence or absence of a contact body. The precharge line PRL applies a precharge voltage to the detection electrode 12E. The read line ROL takes out a voltage from the detection electrode 12E. The precharge gate line PG, coupling pulse line CPL, and read gate line RG supply signals for driving the sensor circuit 12.

The precharge switch SWA is a switch for writing and holding a precharge voltage in the detection electrode 12E. The coupling capacitance Cl causes the detection electrode 12E to produce a potential difference according to a variation in the detected capacitance. The amplification switch SWB is a switch for amplifying a potential difference produced at the detection electrode 12E. The read switch SWC is a switch for outputting and holding the amplified potential difference to and in the read line ROL.

The precharge line PRL and read line ROL share interconnections with the signal line SL. Since one unit of the sensor circuit 12 is provided for a plurality of pixels PXs, a part of the signal lines SLs are shared.

The precharge switch SWA is, for example, a p-type thin-film transistor. The precharge switch SWA has its gate electrode electrically connected to the precharge gate line PG (or integrally formed with the precharge gate line PG), its source electrode electrically connected to the precharge line PRL (or integrally formed with the precharge line PRL), and its drain electrode electrically connected to the detection electrode 12E (or integrally formed with the detection electrode 12E).

The amplification switch SWB is, for example, a p-type thin-film transistor. The amplification switch SWB has its gate electrode electrically connected to the detection electrode 12E (or integrally formed with the detection electrode 12E), its source electrode electrically connected to the coupling pulse line CPL (or integrally formed with the coupling pulse line CPL), and its drain electrode electrically connected to the source electrode of the read switch SWC (or integrally formed with the source electrode SWC).

The read switch SWC is, for example, a p-type thin-film transistor. The read switch SWC has its gate electrode electrically connected to the read gate line RG (or integrally formed with the read gate line RG), its source electrode electrically connected to the drain electrode of the amplification switch SWB (or integrally formed with the drain electrode), and its drain electrode electrically connected to the read line ROL (or integrally formed with the read line ROL).

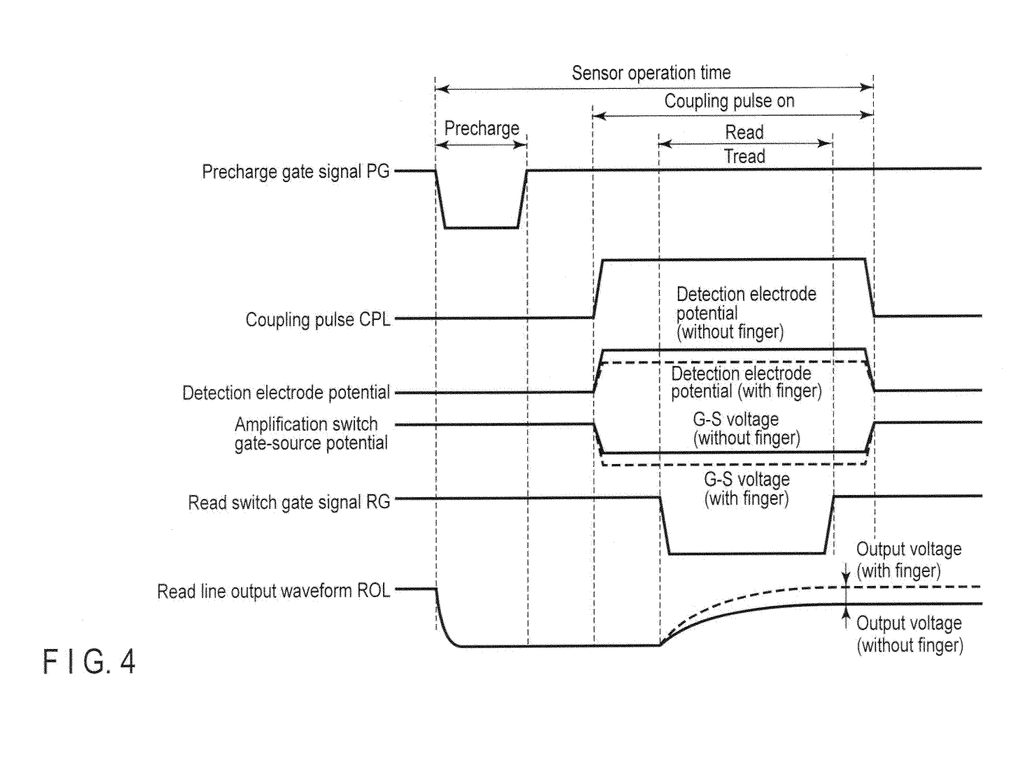

FIG. 4 shows an exemplary timing chart to explain a method of driving the display device 1 according to the embodiment.

A precharge gate line driving waveform (a precharge gate signal waveform) is applied to a precharge gate line PG and input to the gate electrode terminal of a precharge switch SWA. As a result, a precharge voltage Vprc is written from a precharge line PRL to the detection electrode 12E via the precharge switch SWA at the time when a precharge pulse is at an on level (a low level).

The coupling pulse line driving waveform is applied to a coupling pulse line CPL, thereby varying the potential of the detection electrode 12E via a coupling capacitance C1 according to the presence or absence of a contact body. A detection electrode potential waveform shows a variation in the potential of the detection electrode 12E. A potential difference can be produced between a detection electrode potential (without a finger) and a detection electrode potential (with a finger).

The gate-source (GS) voltage waveform of the amplification switch SWB shows that a potential difference produced at the detection electrode 12E is reflected on a difference in the operating point of the amplification switch SWB. A potential difference is produced between a gate-source (GS) voltage (without a finger) and a gate-source (GS) voltage (with a finger). A read gate line driving waveform is applied to a read gate line RG and input to the gate electrode terminal of the read switch SWC.

As a result, a potential after the fluctuation of a coupling pulse is output to the read line ROL via the amplification switch SWB and read switch SWC at the time when a pulse applied to the read gate line RG is at the on level. A voltage waveform output to the read line ROL shows the voltage variation, producing a potential difference between an output voltage (with a finger) and an output voltage (without a finger).

To drive the sensor circuit 12, first, the timing controller TCON controls the scanning line driving circuit YD to make a voltage applied to the precharge gate line PG low, thereby turning on the precharge switch SWA. The timing controller TCON controls the signal line driving circuit XD to apply a precharge voltage to the precharge line PRL, thereby applying a precharge voltage to the detection electrode 12E via the switch SWA.

Next, the timing controller TCON turns off the precharge switch SWA and then controls the scanning line driving circuit YD to make the coupling pulse line CPL high. When the coupling pulse has gone high, the coupling capacitance C1 superposes a voltage on the potential of the detection electrode 12E. At this time, the magnitude of the voltage superposed on the detection electrode 12E depends on the capacitance between the detection electrode 12E and the contact body.

For example, when a finger, a stylus tip, or the like is in contact with the opposite substrate 20 above the detection electrode 12E, a capacitance is produced between the detection electrode 12E and the finger. When a finger, a stylus tip, or the like is in contact with the opposite substrate 20 above the detection electrode 12E, the magnitude of the voltage superposed on the detection electrode 12E becomes smaller than when there is neither a finger nor a stylus tip above the detection electrode 12E.

The on resistance of the amplification switch SWB differs according to the potential of the detection electrode 12E. In the embodiment, when a finger, a stylus tip, or the like is in contact with the opposite substrate 20 above the detection electrode 12E, the on resistance of the amplification switch SWB decreases. When a finger, a stylus tip, or the like is not in contact with the opposite substrate 20 above the detection electrode 12E, the on resistance of the amplification switch SWB becomes relatively high.

Next, the timing controller TCON controls the scanning line driving circuit DY to make the voltage of the read gate line RG low, thereby turning on the read switch SWC. When a finger, a stylus tip, or the like is in contact with the opposite substrate 20 above the detection electrode 12E, if the read switch SWC goes on, a coupling pulse will be supplied to the read line ROL via the amplification switch SWB and read switch SWC.

Therefore, when a finger, a stylus tip, or the like is in contact with the opposite substrate 20, the potential of the read line ROL changes toward the coupling pulse potential. When a finger, a stylus tip, or the like is not in contact with the opposite substrate 20, a change in the potential of the read line ROL becomes smaller than when a finger, a stylus tip, or the like is in contact with the opposite substrate 20.

Accordingly, the position where a finger, a stylus tip, or the like is in contact with the opposite substrate 20 can be detected by detecting the output potential difference between an output voltage (with a finger) and an output voltage (without a finger) after an output period Tread has elapsed since the read gate line PG was turned on.

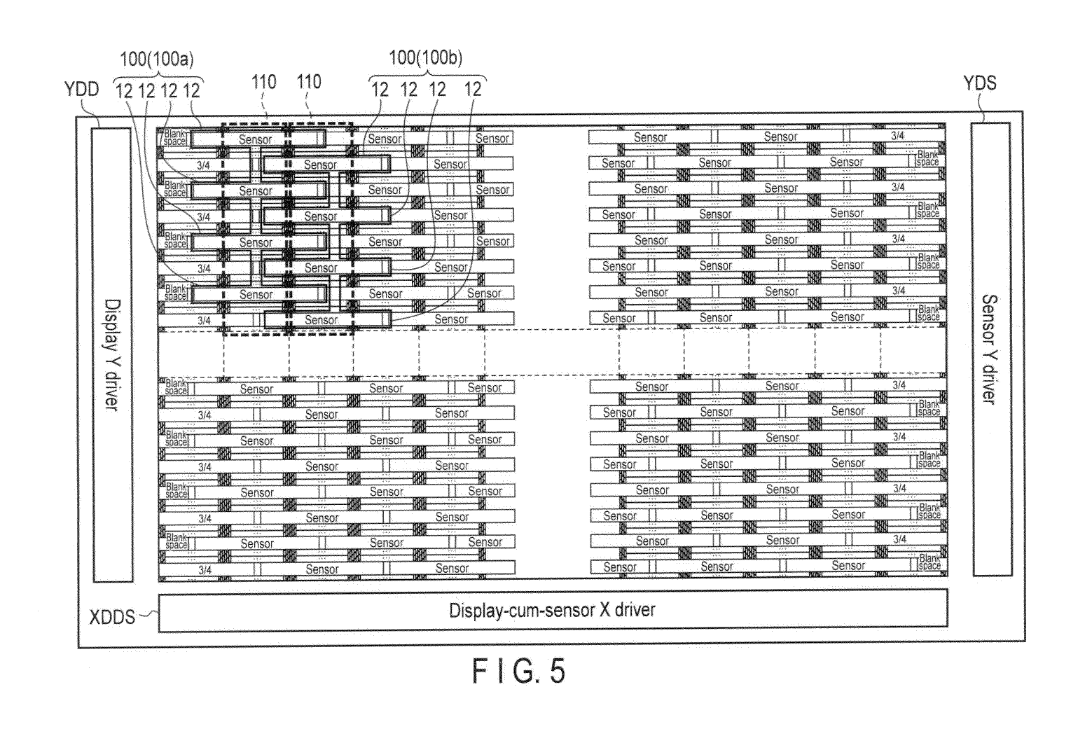

FIG. 5 is an exemplary diagram schematically showing the arrangement of sensors in the display device according to the embodiment. In the arrangement of FIG. 5, there are provided 800(×RGB)×480 display pixels (not shown) and 50×30 sensors 100. A sensor 100 corresponds to a plurality of display pixels.

In FIG. 5, a block 110 enclosed with dotted lines is a repeating unit. The block 110 includes 16(×RGB)×16 display pixels and a sensor 100. Therefore, in the whole display module DYP, 50×30 units of the block 110 are arranged.

In FIG. 5, four sensor circuits 12 are drawn in a block 110. These sensor circuits 12 are electrically connected to one another to function as a sensor 100. The number of sensor circuits 12 in one block 110 is not restricted to four. The sensor circuits 12 need not be arranged at equal intervals in the block 110 and have only to be arranged suitably in the block. In addition, although the arrangement of sensor circuits 12 in a block 110 differs from that in an adjacent one 110, the sensor circuits are not limited to this arrangement and may be arranged suitably in the block. In FIG. 5, for simplicity, two blocks 110 and two sensors 100 are shown and the representation of the other blocks 110 and sensors 100 is omitted.

Next, the operation of sensors configured as described above will be explained. In the explanation below, to distinguish between sensors, two sensors are referred to as sensor 100a and sensor 100b as needed as shown in FIG. 5.

In the display device of the embodiment, two adjacent sensors 100a, 100b cooperate to perform a contact detection operation. Specifically, when sensor 100a performs the operation of reading the magnitude of capacitive coupling (a normal operation), sensor 100b performs the operation of not reading the magnitude of capacitive coupling (a correction operation). A sensor Y driver YDS supplies a coupling pulse to a coupling pulse line CPL in sensor 100a that performs a normal operation, whereas a coupling pulse is not supplied to sensor 100b that performs a correction operation and the sensor Y driver YDS applies a fixed potential to the coupling pulse line CPL.

The output signal of sensor 100a that performs a normal operation includes not only a signal component representing the magnitude of capacitive coupling but also the various noise components described above. On the other hand, the output signal of sensor 100b that performs a correction operation includes only noise components because it does not read the magnitude of capacitive coupling.

Specifically, the output signal of the sensor includes components expressed by the following equations:

Sensor output signal in normal operation=signal component representing magnitude of capacitive coupling+noise component

Sensor output signal in correction operation=noise component

Therefore, using a difference signal obtained from a sensor output signal in a normal operation and that in a correction operation enables noise to be removed or reduced, making it possible to read the magnitude of capacitive coupling more accurately and therefore determine more accurately whether a finger has touched.

The output signals of both sensors 100a, 100b are sent to the control module 65 via the display-cum-sensor X driver XDDS and circuit board 60. The control module 65 performs a difference process, making it possible to read accurately the magnitude of capacitive coupling, that is, the presence or absence of a finger contact, avoiding the influence of noise.

In the above operation, since a sensor operation is performed using the two sensors 100a, 100b as a set, the resolution of the sensor might decrease. To avoid this, the operation of swapping the roles of the two sensors 100a, 100b is added. That is, sensor 100a performs a correction operation and sensor 100b performs a normal operation.

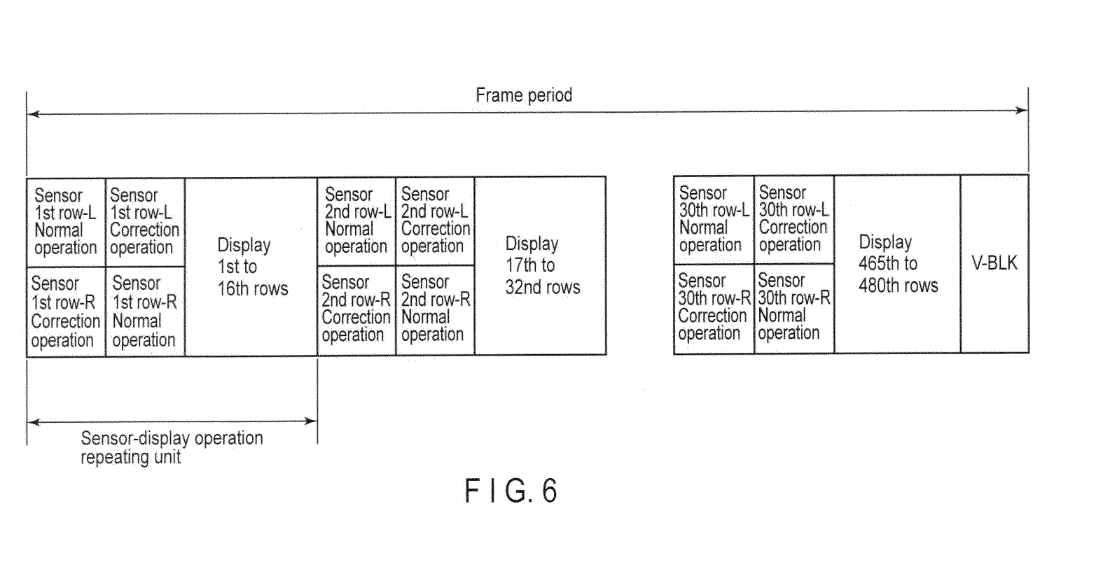

FIG. 6 is an exemplary timing chart to explain the operation of sensors in the display device according to the embodiment.

As described above, there are 50 blocks 110 in the horizontal direction (column) and 30 blocks 110 in the vertical direction (row) in the display module DYP. That is, there are 30 rows of sensors 100 in the display module DYP. Moreover, in the display module DYP, there are 800 display pixels in the horizontal direction (column) and 480 display pixels in the vertical direction (row). Therefore, in a block 110, there are 16(=480/30) rows of display pixels.

In the timing chart of FIG. 6, a sensor operation of a row and a display operation of sixteen rows constitute a sensor-display operation repeating unit. The sensor-display operation repeating unit is repeated 30 times during one frame (normally, 16.7 ms), with the result that all the 30 rows of sensors and all the 480 rows of display pixels are selected.

A sensor operation is performed in the first half of each sensor-display operation repeating unit. First, the left (L) sensor 100a of a set of adjacent sensors 100a, 100b performs a normal operation and the right (R) sensor 100b performs a correction operation. Then, the left and right sensors swap their roles and then operate. Thereafter, a display operation corresponding to 16 rows is performed.

The above sensor-display operation is performed repeatedly, increasing the number of units. Taking difference between the two sensors enables noise components included in the sensor output signals to be removed or reduced.

It is desirable that the operation timing of the left sensor should be almost the same as that of the right sensor so that the noise components included in the left sensor output signal may be almost the same as those included in the right sensor output signal.

[Variations of the Embodiment]

The embodiment can be configured in the form of various variations.

(1) While in the embodiment, a sensor operation has been performed in the first half of each sensor-display operation repeating unit, it may be performed in the second half of each sensor-display operation repeating unit.

(2) While in the embodiment, a touch panel with an active sensor circuit has been explained, the active sensor circuit is not limited to the aforementioned configuration. A touch panel with a passive sensor circuit can be applied in a similar manner.

(3) The display device 1 of the embodiment may be a liquid-crystal display device that employs a twisted nematic (TN) mode, an IPS mode, an optically compensated bend (OCB) mode, or the like as a display mode.

(4) The display device of the embodiment may be applied to a color display device and a black-and-white display device.

(5) The sensor circuit 12 may have the read switch SWC and read gate line RG eliminated. In this case, the drain electrode of the amplification switch SWB is electrically connected to the read line ROL.

(6) A coupling pulse may not be supplied from the gate line GL. For instance, an interconnection in parallel with the signal line SL may be added and used as a coupling pulse line.

(7) The timing controller TCON is not necessarily provided on the circuit board 60 and may be provided outside the circuit board or on a TFT board.

(8) The amplification switch SWB is not limited to the embodiment. It may be configured using an amplifier.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a plurality of display pixels which are arranged in a matrix;
a plurality of sensor circuits which read the magnitude of capacitive coupling;
a module which divides a display surface of the display device into a plurality of regions composed of a plurality of display pixels and a plurality of sensor circuits and which causes a part of the sensors in each of the regions to perform a normal operation of reading the magnitude of capacitive coupling;
a module which causes the other sensor circuits in the same region to perform a correction operation of not reading the magnitude of capacitive coupling; and
a module which determines the magnitude of capacitive coupling using the difference between output signals from the sensor circuits that perform the normal operation in the corresponding regions and output signals from the sensor circuits that perform the correction operation.

2. The display device of claim 1, further comprising a module which causes the normal operation and the correction operation to be performed almost at the same time.

3. The display device of claim 2, further comprising a module which swaps the sensor circuit that performs the normal operation and the sensor circuit that performs the correction operation with each other in operation and causes the sensor circuits to perform the normal operation and the correction operation.

4. The display device of claim 3, further comprising a module which causes the display pixels to display an image after causing the sensor circuits to perform the normal operation and correction operation in each of the regions.

5. The display device of claim 4, wherein the number of display pixels and the number of sensor circuits included in each of the regions are the same.

6. The display device of claim 5, wherein the sensor circuit that performs the normal operation and the sensor circuit that performs the correction operation are arranged to be adjacent to each other in each of the regions.

7. The display device of claim 6, wherein the sensor circuit that performs the normal operation and the sensor circuit that performs the correction operation are arranged to be staggered in a row direction.

8. The display device of claim 2, further comprising a module which causes the display pixels to display an image after causing the sensor circuits to perform the normal operation and correction operation in each of the regions.

9. The display device of claim 8, wherein the number of display pixels and the number of sensor circuits included in each of the regions are the same.

10. The display device of claim 9, wherein the sensor circuit that performs the normal operation and the sensor circuit that performs the correction operation are arranged to be adjacent to each other in each of the regions.

11. The display device of claim 10, wherein the sensor circuit that performs the normal operation and the sensor circuit that performs the correction operation are arranged to be staggered in a row direction.

12. The display device of claim 1, wherein the sensor circuit includes a coupling capacitance that produces capacitive coupling, a module that varies the potential at one end of the coupling capacitance, a detection electrode that is connected to the other end of the coupling capacitance, and a module that reads the potential of the detection electrode, and the module that performs the correction operation causes the potential at one end of the coupling capacitance to remain unchanged in the correction operation.
